(19) United States
(12) Patent Application Publication
(10) Pub. No.: US 2021/0339703 A1
(43) Pub. Date: Nov. 4, 2021

(54) VEHICLE CONTROL APPARATUS AND VEHICLE CONTROL METHOD

(71) Applicant: MANDO CORPORATION, Pyeongtaek (KR)

(72) Inventor: Dongwook Lee, Seongnam (KR)

(21) Appl. No.: 17/235,806

(22) Filed: Apr. 20, 2021

(30) Foreign Application Priority Data
Apr. 29, 2020 (KR) 10-2020-0052043

(51) Int. Cl. B60R 25/102; B60R 25/04; B60N 2/00; G06K 9/00; G01G 19/12; B60K 35/00

(52) U.S. Cl. CPC B60R 25/102; B60R 25/04; B60N 2/002; G06K 9/00838; B60K 2370/589; G01G 19/12; B60K 35/00; B60K 2370/741; B60K 2370/1438; G06K 9/00255

(57) ABSTRACT

An apparatus for assisting driving of a host vehicle includes: a plurality of pressure sensors mounted in a driver's seat of the host vehicle; and a controller electrically connected to the plurality of pressure sensors, and the controller is configured to: receive an output signal of the plurality of pressure sensors, determine whether a child is seated in the driver's seat based on the output signal, and control a wireless communication module of the host vehicle to transmit an alarm to a user device registered in the host vehicle based on determining that the child is seated and the child inputs an input for starting the host vehicle. Thereby, accidents caused by children driving the vehicle are prevented.

### CROSS-REFERENCE TO RELATED APPLICATION

This application is based on and claims priority under 35 U.S.C. § 119 to Korean Patent Application No. 10-2020-0052043, filed on Apr. 29, 2020 in the Korean Intellectual Property Office, the disclosure of which is incorporated herein by reference.

### BACKGROUND

### 1. Technical Field

The present disclosure relates to a vehicle control apparatus and a vehicle control method, and more particularly, to a vehicle control apparatus and a vehicle control method capable of detecting the presence of a child in a drivers seat.

### 2. Description of the Related Art

Vehicles are the most common means of transportation in modern society, and the number of people using them is increasing.

For the convenience of the driver, functions that allow the driver to easily start the vehicle have been added. For example, if a remote starting device (e.g., a smart key) is located near the vehicle, the vehicle can unlock the door in response to the drivers touch, and can start the vehicle in response to a push of a button for starting.

These convenience features of the vehicle enable children as well as adult drivers to start and drive the vehicle without restrictions in the driver's seat. In addition, the number of accidents is increasing due to this.

### SUMMARY

For the above reasons, an aspect of the present disclosure is to provide a vehicle control apparatus and a vehicle control method capable of detecting that a child is seated a driver's seat.

Therefore, it is an aspect of the present disclosure to provide an apparatus for assisting driving of a host vehicle including: a plurality of pressure sensors mounted in a driver's seat of the host vehicle; and a controller electrically connected to the plurality of pressure sensors, and the controller is configured to: receive an output signal of the plurality of pressure sensors, determine whether a child is seated in the driver's seat based on the output signal, and control a wireless communication module of the host vehicle to transmit an alarm to a user device registered in the host vehicle based on determining that the child is seated and the child inputs an input for starting the host vehicle.

It is another aspect of the present disclosure to provide an apparatus for assisting driving of a host vehicle including: a camera module configured to photograph a driver's seat of the host vehicle; and a controller electrically connected to the camera module, and the controller is configured to: receive an image data of the camera module, determine whether a child is seated in the driver's seat based on the image data, and control a wireless communication module of the host vehicle to transmit an alarm to a user device registered in the vehicle based on determining that the child is seated and the child inputs an input for starting the host vehicle.

It is another aspect of the present disclosure to provide an apparatus for assisting driving of a host vehicle including: a touch screen configured to acquire a touch input of a driver of the host vehicle; and a controller electrically connected to the touch screen, and the controller is configured to: receive a touch input of the touch screen, determine whether a child is seated in the driver's seat based on the touch input, and control a wireless communication module of the host vehicle to transmit an alarm to a user device registered in the host vehicle based on determining that the child is seated and the child inputs an input for starting the host vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a configuration of a vehicle control apparatus according to an embodiment;

FIG. 2 illustrates a child boarding a vehicle equipped with a vehicle control apparatus according to an embodiment;

FIG. 3 illustrates a child seated on a seat of a vehicle equipped with a vehicle control apparatus according to an embodiment;

FIG. 4 illustrates image data of a child photographed by a camera included in a vehicle control apparatus according to an embodiment;

FIG. 5 illustrates a child's hand detected by a touch screen included in a vehicle control apparatus according to an embodiment;

FIG. 6 illustrates a vehicle control method of a vehicle control apparatus according to an embodiment; and

FIG. 7 illustrates a vehicle control method of a vehicle control apparatus according to an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference will now be made in detail to the exemplary embodiments of the present disclosure, examples of which are illustrated in the accompanying drawings, wherein like reference numerals refer to like elements throughout.

The expression, “at least one of a, b, and c,” should be understood as including only a, only b, only c, both a and b, both a and c, both b and c, or all of a, b, and c.

Hereinafter, the principles and embodiments of the disclosure will be described with reference to the accompanying drawings.

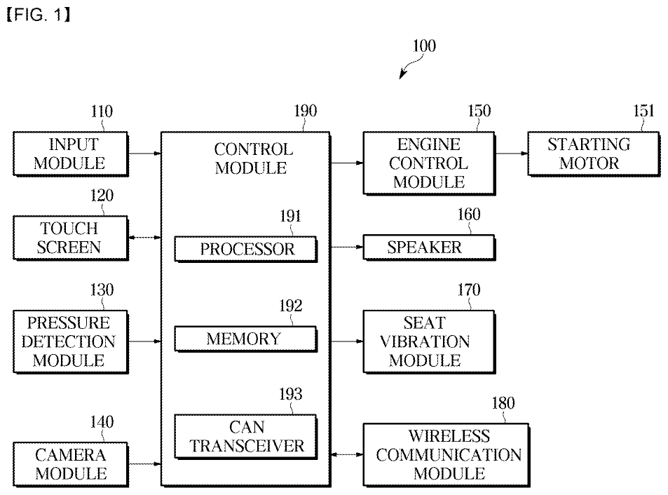

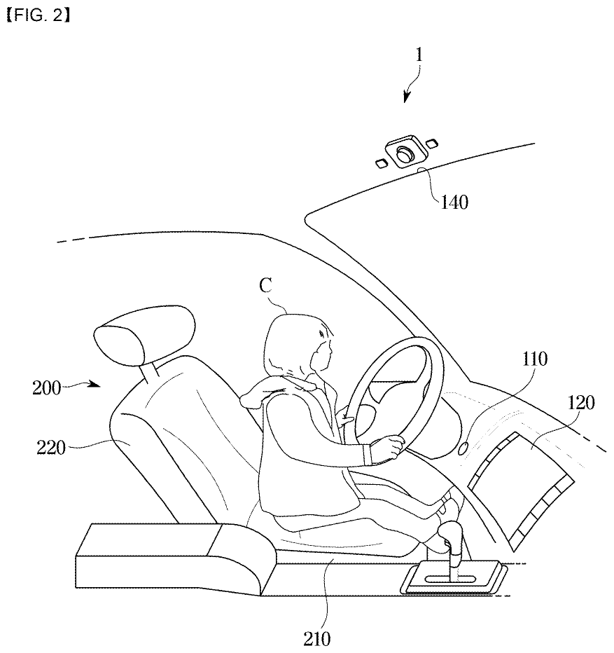

FIG. 1 illustrates a configuration of a vehicle control apparatus according to an embodiment. FIG. 2 illustrates a child boarding a vehicle equipped with a vehicle control apparatus according to an embodiment.

Referring to FIGS. 1 and 2, the vehicle control apparatus 100 includes a starting input module 110, a touch screen 120, a pressure detection module 130, a camera module 140, and an engine control module 150, a speaker 160, a seat vibration module 170, a wireless communication module 180, and a control module 190.

The starting input module 110 may acquire an input for starting the vehicle 1 from a driver. For example, the starting input module 110 may include a key groove into which a key of the vehicle 1 carried by the driver may be inserted. As another example, the starting input module 110 may include a switch capable of detecting an operation that the driver presses. The starting switch may be located near the steering wheel as shown in FIG. 2, and if a driver holding an electronic key presses the switch, the starting input module 110 may acquire an input for starting.

The starting input module 110 may be electrically connected to the control module 190. For example, the starting input module 110 may be directly connected to the control module 190 through a hard wire or cable. Alternatively, the starting input module 110 may be connected to the control module 190 through a communication network for a vehicle. For example, the starting input module 110 may exchange data with the control module 190 through Ethernet, Media Oriented Systems Transport (MOST), Flexray, Controller Area Network (CAN), Local Interconnect Network (LIN), etc.

If an input for starting the vehicle 1 is obtained from the driver, the starting input module 110 may provide an electric signal (starting signal) indicating the input for starting to the control module 190.

The touch screen 120 may acquire a driver's touch input and display an image in response to the touch input. The touch screen 120 may include a touch panel capable of detecting a driver's touch and identifying a touched position based on a change in capacitance or a change in electric resistance and a display panel capable of converting image data, which is an electrical signal, into an optical signal (image).

The touch screen 120 may be provided on a center fascia inside the vehicle 1 as shown in FIG. 2 so as not to deviate from the driver's view while driving.

The touch screen 120 may be provided as various types of devices. For example, the touch screen 120 may be a multimedia device for a vehicle, and may display a still image or a video in response to a driver's touch input. In addition, the touch screen 120 may be a navigation device, and may display an image indicating a route to a destination in response to a driver's touch input.

The touch screen 120 may be electrically connected to the control module 190. For example, the touch screen 120 may be directly connected to the control module 190 or may be connected to the control module 190 through a communication network for a vehicle. The touch screen 120 may receive image data from the control module 190 and may display an image corresponding to the image data. In addition, the touch screen 120 may transmit information on a driver's touch input input while an image is displayed to the control module 190.

The pressure detection module 130 may measure the driver's weight or detect the driver's body shape.

The pressure detection module 130 may include, for example, a plurality of pressure sensors distributed and mounted on the driver's seat 200. Each of the plurality of pressure sensors may measure the pressure applied to the sensor. For example, each of the plurality of pressure sensors may include a strain gauge whose electrical characteristics (eg, electrical resistance values) change in response to pressure or stress.

The pressure detection module 130 may be electrically connected to the control module 190. For example, the pressure detection module 130 may be directly connected to the control module 190 or may be connected to the control module 190 through a communication network for a vehicle. The pressure detection module 130 may measure pressure applied to a pressure sensor and transmit an electrical signal (pressure signal) corresponding to the measured pressure to the control module 190.

The camera module 140 may photograph the inside of the vehicle 1, particularly the driver, and acquire the photographed image data. The camera module 140 may include, for example, an image sensor that converts light into an electrical signal, and the image sensor may include a plurality of photodiodes arranged in two dimensions.

The camera module 140 may be mounted, for example, on the interior ceiling of the vehicle 1 as shown in FIG. 2. However, the mounting position of the camera module 140 is not limited thereto, and may be mounted on a rear view mirror.

The field of view of the camera module 140 may include a driver's seat 200 in which a driver may be seated. If the driver is on board, the camera module 140 may photograph the inside of the vehicle 1 including the driver.

The camera module 140 may be electrically connected to the control module 190. For example, the camera module 140 may be directly connected to the control module 190 or may be connected to the control module 190 through a communication network for a vehicle. The camera module 140 may photograph the inside of the vehicle 1, particularly the driver, and transmit the photographed image data to the control module 190.

The engine control module 150 may control the engine in response to a driver's willingness to accelerate through an accelerator pedal or a request from the driver assistance device 100. For example, the engine control module 150 may control the rotational speed and torque of the engine.

The engine control module 150 may control the starting motor 151 to start the engine. The starting motor 151 may provide rotational force to the engine to start the engine while the engine is stopped.

The engine control module 150 may be electrically connected to the control module 190. For example, the engine control module 150 may be directly connected to the control module 190 or may be connected to the control module 190 through a communication network for a vehicle. The engine control module 150 may receive a starting signal for starting from the control module 190 and may control the starting motor 151 to start the engine in response to the starting signal.

The speaker 160 may convert an electrical signal into a sound. The speaker 160 may be classified into several types according to the frequency of the sound to be output. For example, the speaker 160 may include a tweeter that converts a high-frequency electrical sound signal into a high-frequency sound, a squawker (midrange speaker) that converts an electrical sound signal of an intermediate frequency to a sound of an intermediate frequency, and a woofer that converts a low-frequency electrical sound signal to low-frequency sound.

The speaker 160 may be mounted on the door of the vehicle 1, for example, as shown in FIG. 2.

The speaker 160 may be provided as a device of various types. For example, the speaker 160 may be a part of vehicle audio, may receive an electrical signal from a head unit or a multimedia device mounted in the center fascia of the vehicle 1, and convert the received electrical signal into sound.

The speaker 160 may be electrically connected to the control module 190. For example, the speaker 160 may be directly connected to the control module 190 or may be connected to the control module 190 through a communication network for a vehicle. The speaker 160 may receive an electrical signal from the control module 190 and may output a sound converted from the received electrical signal.

The seat vibration module 170 is mounted on the driver's seat 200 and may vibrate the driver's seat 200. The seat vibration module 170 may include a motor and a weight eccentrically connected to the shaft of the motor. An eccentric weight is additionally rotated with the rotation of the motor, and the seat vibration module 170 may vibrate the driver's seat 200 by using the rotation of the eccentric weight.

The seat vibration module 170 may be electrically connected to the control module 190. For example, the seat vibration module 170 may be directly connected to the control module 190 or may be connected to the control module 190 through a communication network for a vehicle. The seat vibration module 170 may receive a control signal for vibration of the seat from the control module 190 and may vibrate the driver's seat 200 in response to the control signal.

The wireless communication module 180 may wirelessly communicate with an external device. For example, the wireless communication module 180 may communicate with a driver's registered user device. The wireless communication module 180 may wirelessly exchange data with a base station, and the base station may exchange data with a driver's registered user device through a private communication network or the internet.

The wireless communication module 180 may communicate with an external device (eg, a base station) in a mobile communication method. The wireless communication module 180 may use, for example, a second generation (2G) communication method such as Time Division Multiple Access (TDMA) and Code Division Multiple Access (CDMA), or a third generation (3G) communication method such as Wide Code Division Multiple Access (WCDMA), Code Division Multiple Access 2000 (CDMA2000), Wireless Broadband (Wibro) and World Interoperability for Microwave Access (WiMAX), or a fourth generation (4G) communication method such as Long Term Evolution (LTE) and Wireless Broadband Evolution, or a fifth generation (5G) communication method.

In addition, the wireless communication module 180 may communicate with an external device (eg, a base station) in a short-range wireless communication method. The wireless communication module 180 may use, for example, a Dedicated Short Range Communication (DSRC) communication method, a wireless access in vehicular environments (WAVE) communication method, or a wireless fidelity (WiFi) communication method.

The control module 190 may include a plurality of semiconductor devices, and may be referred to in various ways, such as an Electronic Control Unit (ECU) or the like. The control module 190 includes a CAN transceiver 193, a memory 192 and a processor 191. The CAN transceiver 193, the memory 192, and the processor 191 may be implemented as separate semiconductor devices, or may be implemented as a single semiconductor device. The control module 190 may include a plurality of processors and/or a plurality of memories.

The CAN transceiver 193 may exchange data with the starting input module 110, the touch screen 120, the pressure detection module 130, the camera module 140, the engine control module 150, the speaker 160, the seat vibration module 170 and the wireless communication module 180 through a communication network for a vehicle.

The memory 192 may store programs and data for controlling the operation of the control module 190. In addition, the memory 192 may provide programs and data to the processor 191 and store temporary data generated during a computational operation of the processor 191.

The memory 192 may include a volatile memory such as a Static Random Access Memory (S-RAM) and a Dynamic Random Access Memory (D-RAM), and a nonvolatile memory such as a Read Only Memory (ROM), an Erasable Programmable Read Only Memory (EPROM) and flash memory. The memory 192 may include one semiconductor device or may include a plurality of semiconductor devices.

The processor 191 may process a starting signal of the starting input module 110, a touch signal of the touch screen 120, a pressure signal of the pressure detection module 130, and image data of the camera module 140 according to the program and data provided from the memory 192. In addition, the processor 191 may generate a control signal for controlling the engine control module 150, the speaker 160, the seat vibration module 170, and the wireless communication module 180 according to the program and data provided from the memory 192.

The processor 191 may include an operation circuit, a memory circuit, and a control circuit. The processor 191 may include one semiconductor device or may include a plurality of semiconductors. In addition, the processor 191 may include one core or a plurality of cores in one semiconductor device. Such a processor 191 may be referred to in various ways, such as a Micro Processing Unit (MPU) or the like.

The control module 190 may acquire a driver's starting input from the starting input module 110. In addition, the control module 190 may acquire a driver's touch input from the touch screen 120, acquire information about the pressure applied to the driver's seat 200 from the pressure detection module 130, and acquire internal image data of a vehicle including a driver from the camera module 140.

The control module 190 may identify whether the child C is seated in the driver's seat of the vehicle 1. For example, as shown in FIG. 2, due to the convenience function of the vehicle 1, not only the registered driver but also the child C may start and drive the vehicle without restrictions in the driver's seat. To prevent this, the control module 190 may identify whether the child C is seated in the driver's seat based on the touch signal of the touch screen 120, the pressure signal of the pressure detection module 130 and/or the image data of the camera module 140.

A specific method of identifying whether the child C is seated in the driver's seat of the vehicle 1 by the control module 190 will be described in more detail below.

If it is identified that the child C is seated in the driver's seat of the vehicle 1, the control module 190 may transmit a control signal to the speaker 160 and/or the seat vibration module 170 and/or the wireless communication module 180 in order to induce the child C to get off the driver's seat 200. For example, the control module 190 may transmit an electrical signal to the speaker 160 to output a sound for requesting the child C to get off the vehicle 1. The control module 190 may transmit a control signal to the seat vibration module 170 to vibrate the driver's seat 200 in order to induce the child C to get off the vehicle 1.

If a driver's input for starting through the starting input module 110 is received while it is identified that the child C is seated in the driver's seat of the vehicle 1, the control module 190 may transmit a control signal to the wireless communication module 180 in order to inform the registered driver of the vehicle 1 that the child C is seated the drivers seat 200.

In addition, if it is identified that the child C is seated in the driver's seat of the vehicle 1 while the starting of the vehicle 1 is turned on, the control module 190 may transmit a control signal to the engine control module 150 to turn off starting of the vehicle 1.

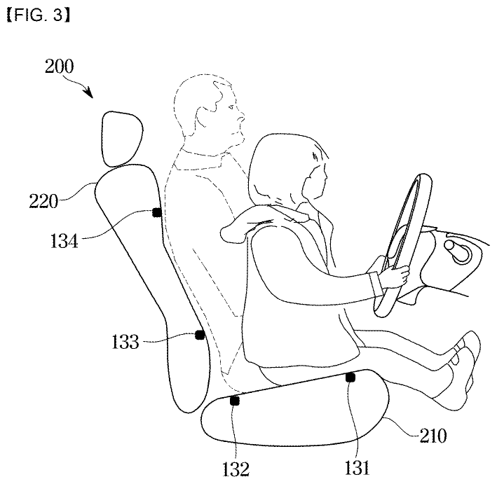

FIG. 3 illustrates a child seated on a seat of a vehicle equipped with a vehicle control apparatus according to an embodiment.

The pressure detection module 130 may include a plurality of pressure sensors as shown in FIG. 3. The plurality of pressure sensors 131, 132, 133, and 134 may be distributed and installed in the drivers seat 200, respectively. For example, as shown in FIG. 2, the first pressure sensor 131 may be mounted in front of the seat body 210 of the drivers seat 200. The second pressure sensor 132 may be mounted at the rear of the seat body 210 of the driver's seat 200. The third pressure sensor 133 may be mounted on the lower side of the backrest 220 of the driver's seat 200. The fourth pressure sensor 134 may be mounted on the upper side of the backrest 220 of the driver's seat 200.

If the driver or child C is seated in the driver's seat 200, the plurality of pressure sensors 131, 132, 133 and 134 may measure the applied pressure and transmit a pressure signal corresponding to the measured pressure to the control module 190.

The control module 190 may identify whether the child C is seated in the driver's seat 200 based on the pressure signals received from the plurality of pressure sensors 131, 132, 133 and 134.

For example, the control module 190 may estimate the weight of a driver seated in the driver's seat 200 based on the pressure signals received from the plurality of pressure sensors 131, 132, 133, and 134. If the driver is seated in the driver's seat 200, the pressure is applied to the seat body 210 and the backrest 220 by the driver's body.

In the control module 190, a lookup table including the weight of the driver corresponding to the pressure applied to each of the seat body 210 and the backrest 220 is stored in advance. The control module 190 acquires pressure signals output from the first and second pressure sensors 131 and 132 of the seat body 210 and acquires pressure signals output from the third and fourth pressure sensors 133 and 134 of the backrest 220, and may estimate the weight of the driver seated in the driver's seat 200 by referring to the lookup table.

If the estimated weight of the driver is less than the predetermined reference weight, the control module 190 may identify that the child C is seated in the driver's seat 200. If the estimated driver's weight is a predetermined reference weight or more, the control module 190 may identify that an adult driver is seated in the driver's seat 200. The reference weight may be set experimentally or empirically, and may be set in advance based on an average weight for each age group.

As another example, the control module 190 may identify whether the child C is seated in the driver's seat 200 based on not receiving a pressure signal from some of the plurality of pressure sensors 131, 132, 133, and 134.

As shown in FIG. 3, if an adult driver is seated in the driver's seat 200, pressure may be applied to both the seat body 210 and the backrest 220 by the driver. Thereby, all of the first to fourth pressure sensors 131, 132, 133, and 134 may output a pressure signal. On the other hand, if the child C is seated in the driver's seat 200, pressure may be applied only to the lower portions of the seat body 210 and the backrest 220 by the child C. Accordingly, the first pressure sensor 131 may output an input signal, and the second, third, and fourth pressure sensors 132, 133, and 134 may not output the pressure signal.

The control module 190 may identify that the child C is seated in the driver's seat 200 if a pressure signal is not received from some of the plurality of pressure sensors 131, 132, 133, and 134.

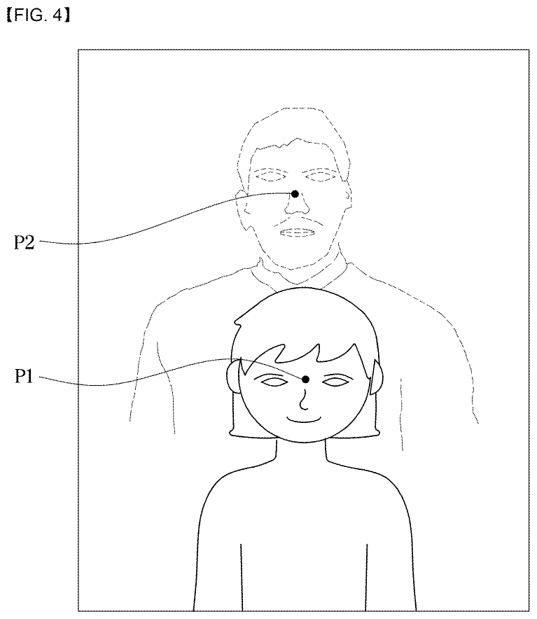

FIG. 4 illustrates image data of a child photographed by a camera included in a vehicle control apparatus according to an embodiment.

The camera module 140 may be mounted on an interior ceiling or a rear view mirror of the vehicle 1 and may have a view toward the rear. The camera module 140 may acquire image data including an image of a driver seated in the driver's seat, and transmit the acquired image data to the control module 190.

The control module 190 may identify whether the child C is seated in the driver's seat 200 based on image data received from the camera module 140.

The control module 190 recognizes the driver's face included in the image data using a face recognition algorithm, and may identify whether the child C is seated in the driver's seat 200 based on the recognized center position of the face (coordinates in the image). Since the position of the camera module 140 is fixed, the center position (coordinates in the image) of the driver's face seated in the driver's seat 200 in the image photographed by the camera module 140 may depend on the driver's body shape and height.

If an adult driver is seated in the driver's seat 200, the center position P2 of the driver's face may be located at the upper part of the image as shown in FIG. 3. If a child C is seated in the driver's seat 200, the center position P1 of the driver's face may be located at the lower part of the image as shown in FIG. 3. If the center position of the driver's face is located below the reference position, the control module 190 may identify that the child C is seated in the driver's seat 200. If the center position of the driver's face is located above the reference position, the control module 190 may identify that an adult driver is seated in the driver's seat 200. The reference position may be set experimentally or empirically, and may depend on the position of the camera module 140.

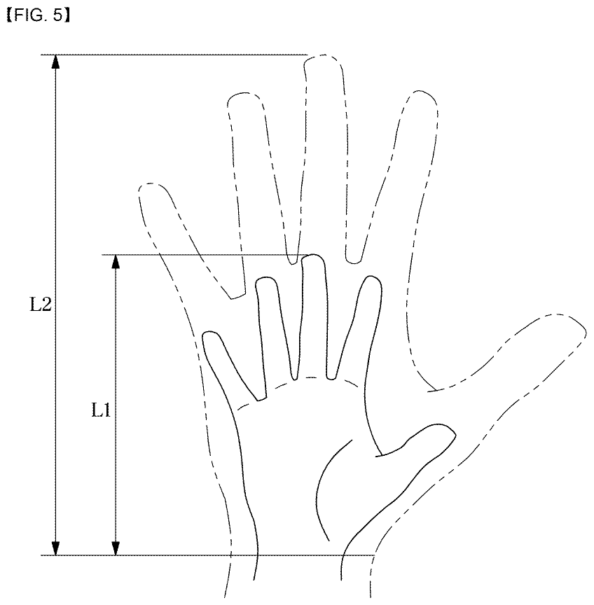

FIG. 5 illustrates a child's hand detected by a touch screen included in a vehicle control apparatus according to an embodiment.

The touch screen 120 may be provided on the center fascia inside the vehicle 1, and may identify a touch by a part of the driver's body (eg, hand, finger, palm, etc.) and determine the touch position. If a plurality of touches are simultaneously detected, the touch screen 120 may output coordinates of the center, coordinates of the top, coordinates of the bottom, coordinates of the leftmost side, and coordinates of the rightmost side of the touched area.

The touch screen 120 may induce the driver to contact the entire palm of the driver with the touch screen 120. As shown in FIG. 5, if the driver touches the palm to the touch screen 120, the touch screen 120 may transmit the coordinates of the center, the coordinates of the top, the coordinates of the bottom, the coordinates of the leftmost side, and the coordinates of the rightmost side of the touched area to the control module 190.

The control module 190 determines a difference between the coordinates of the top and the bottom of the touch position (eg, Y-axis coordinate) detected by the touch screen 120, and may determine the difference as the size of the driver's hand. For example, as shown in FIG. 5, the difference L2 between the coordinates of the top and the bottom of the touch position detected from the hand of an adult is greater than the difference L1 between the coordinates of the top and the bottom of the touch position detected from the hand of the child C.

If the difference between the coordinates of the top and bottom of the touch position is less than the reference value, the control module 190 determines that the driver is a child (C). If the difference between the coordinates of the top and bottom of the touch position is greater than or equal to the reference value, the control module 190 may determine that the driver is an adult. The reference value may be set empirically or experimentally, and may be set in advance based on an average hand size by age.

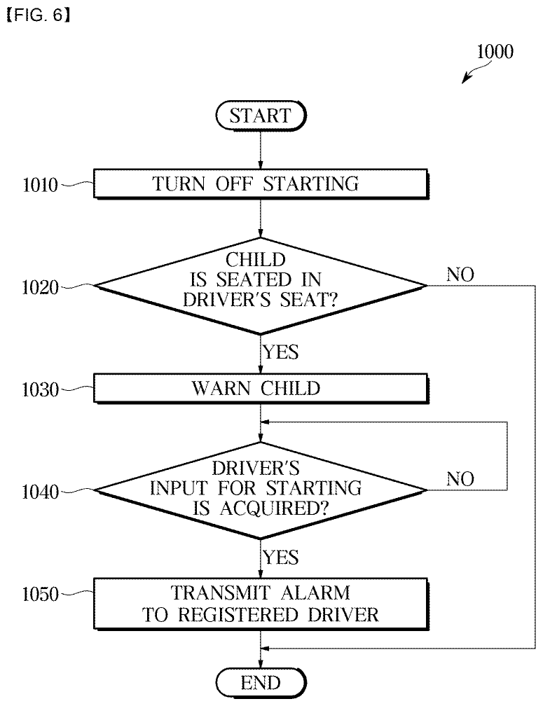

FIG. 6 illustrates a vehicle control method of a vehicle control apparatus according to an embodiment.

Referring to FIG. 6, a vehicle control method 1000 of the vehicle control apparatus 100 is described.

The vehicle 1 is in a state in which the starting of the vehicle is turned off (1010).

Before the driver boards, the vehicle 1 may be in a parked state. During parking, the vehicle 1 may be in a state in which the starting of the vehicle is turned off.

Even when the starting is turned off, power may be supplied to some of the electrical components of the vehicle 1. For example, power may be supplied to a door lock that locks a door or unlocks the door even when the starting of the vehicle 1 is turned off.

The vehicle control apparatus 100 determines whether the child Cis seated in the driver's seat (1020).

In response to the driver's input, the vehicle 1 may unlock the door. For example, if the driver inserts the key into the key groove or a door unlock signal from a remote starting device (e.g., a smart key) is received, the vehicle 1 may control the door lock to unlock the door.

Thereafter, if the door is unlocked, power may be supplied to the pressure detection module 130 for identifying the body shape or weight of the driver in the vehicle 1. In addition, power may be supplied to the camera module 140 for photographing an image including a driver who boards the vehicle 1.

The driver may be seated in the driver's seat 200 after opening the door. If the driver is seated in the driver's seat 200, the control module 190 may identify whether the child C is seated in the driver's seat based on an output signal (pressure signal) received from the pressure detection module 130 or image data received from the camera module 140.

For example, the control module 190 may estimate the weight of a driver seated in the driver's seat 200 based on the pressure signals received from the plurality of pressure sensors 131, 132, 133, and 134. If the estimated weight of the driver is less than a predetermined reference weight, the control module 190 may identify that the child Cis seated in the driver's seat 200.

The control module 190 may identify whether the child Cis seated in the driver's seat 200 based on not receiving a pressure signal from some of the plurality of pressure sensors 131, 132, 133, and 134. in addition, the control module 190 recognizes the driver's face included in the image data using a face recognition algorithm, and may identify whether the child C is seated in the driver's seat 200 based on the recognized position of the face (coordinates in the image).

If it is identified that the child C is not seated the driver's seat (NO in 1020), the vehicle control apparatus 100 starts the vehicle in response to the driver's input.

The driver may input a driver's input for starting the vehicle 1 through the starting input module 110, and the control module 190 may transmit a control signal for starting the vehicle 1 to the engine control module 150 in response to a driver's input input through the starting input module 110. The engine control module 150 may control the starting motor 151 to start the vehicle 1.

If it is identified that the child C is seated in the driver's seat (YES in 1020), the vehicle control apparatus 100 warns the child C (1030).

The control module 190 may warn the child C seated in the driver's seat 200 to get off the vehicle through an image and/or sound and/or tactile sense. For example, the control module 190 may control the speaker 160 to output a voice message warning the child C seated in the driver's seat 200 to get off. The control module 190 may control the touch screen 120 to output an image message warning the child C to get off. In addition, the control module 190 may control the seat vibration module 170 to vibrate the driver's seat 200 to warn the child C to get off.

The vehicle control apparatus 100 determines whether or not a driver's input for starting is acquired (1040).

The control module 190 may determine whether the child C operates the starting input module 110 to start the vehicle 1. Despite warning to get off, child C may press the start button to start vehicle 1.

The control module 190 may determine whether to acquire a driver's input for starting based on a starting signal output from the starting input module 110.

If the driver's input for starting is not acquired (NO in 1040), the vehicle 1 may continue to warn the child C seated in the driver's seat 200 to get off.

If the driver's input for starting is acquired (YES in 1040), the vehicle control apparatus 100 transmits an alarm to the driver's registered user device (1050).

If it is determined that the child C presses the start button to start the vehicle 1, the control module 190 may not transmit a start-on signal to the engine control module 150 so as not to start the vehicle 1 despite the starting signal. Alternatively, the control module 190 may transmit a start-off signal to the engine control module 150 so as not to start the vehicle 1.

In addition, the control module 190 may control the wireless communication module 180 to transmit an alarm to the driver's registered user device.

The control module 190 may notify the owner or driver of the vehicle 1 that the child C is seated in the driver's seat through an alarm through the wireless communication module 180.

As such, the vehicle 1 may determine whether the child C is seated in the driver's seat 200 while the starting of the vehicle is turned off, and induce the child C to get off if it is determined that the child C is seated. In addition, the vehicle 1 may inform the driver that the child C is seated in the driver's seat.

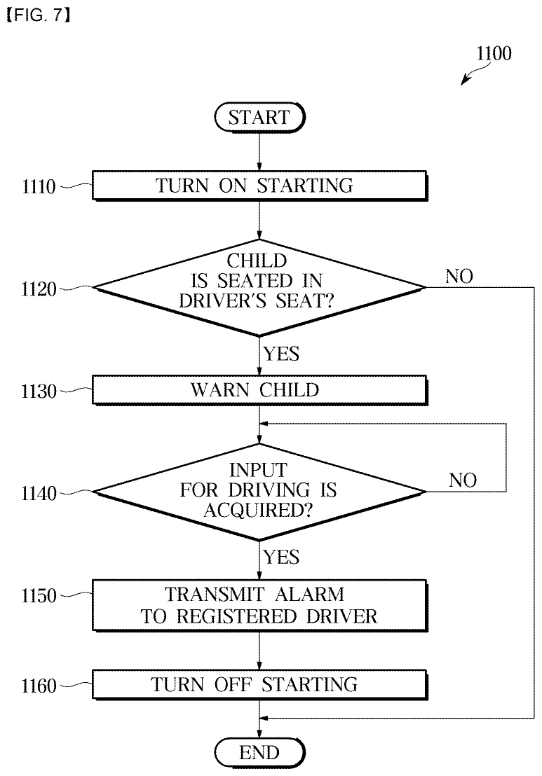

FIG. 7 illustrates a vehicle control method of a vehicle control apparatus according to an embodiment.

Referring to FIG. 7, a vehicle control method 1100 of the vehicle control apparatus 100 is described.

The vehicle 1 is in a state in which the starting of the vehicle is turned on (1100).

The vehicle 1 may be in a stopped state in which the starting of the vehicle is turned on. While the starting is turned on, electric power may be supplied to most of the electrical components of the vehicle 1.

The vehicle control apparatus 100 determines whether the child C is seated in the driver's seat (1120).

If the driver is seated in the driver's seat 200, the control module 190 may determine whether the seated driver is the child. For example, the control module 190 may determine whether the child C is seated in the driver's seat 200 based on the pressure signal received from the plurality of pressure sensors 131, 132, 133 and 134 or image data received from the camera module 140.

Also, the control module 190 may determine whether the child C is seated in the driver's seat 200 based on a touch input received from the touch screen 120. The touch screen 120 may induce the driver to contact the entire palm of the driver with the touch screen 120, and if the driver touches the palm to the touch screen 120, the touch screen 120 may transmit the touch coordinates to the control module 190. The control module 190 may determine the size of the driver's hand based on the touch position (eg, Y-axis coordinate) detected by the touch screen 120. Also, the control module 190 may determine whether the child C is seated in the driver's seat 200 based on the size of the driver's hand.

If it is identified that the child C is not in the driver's seat (NO in 1120), the vehicle 1 travels in response to the driver's input.

If it is identified that the child C is seated in the driver's seat (YES in 1020), the vehicle control apparatus 100 warns the child C (1130).

Operation 1130 may be the same as operation 1030 illustrated in FIG. 6.

The vehicle control apparatus 100 determines whether or not a driver's input for driving is acquired (1140).

The control module 190 may determine whether the child C operates an accelerator pedal, a shift lever, a brake pedal, or a steering wheel to drive the vehicle 1. Despite warning to get off the vehicle, the child C may operate the accelerator pedal, the shift lever, the brake pedal, or the steering wheel to drive the vehicle 1.

The control module 190 may determine whether to acquire a driver's input for driving based on an output signal output from the accelerator pedal, the shift lever, the brake pedal, or the steering wheel.

If the driver's input for starting is not acquired (NO in 1140), the vehicle control apparatus 100 may continue to warn the child C seated in the driver's seat 200 to get off.

If the driver's input for starting is acquired (YES in 1140), the vehicle control apparatus 100 transmits an alarm to the driver's registered user device (1150).

Operation 1150 may be the same as operation 1050 illustrated in FIG. 6.

The vehicle control apparatus 100 turns off the starting of the vehicle 1 (1160).

If it is determined that the child C operates the accelerator pedal, the shift lever, the brake pedal or the steering wheel to drive the vehicle 1, the control module 190 may transmit a start-off signal to the engine control module 150 to turn off the staring of the vehicle 1.

As such, the vehicle 1 determines whether the child C is seated in the driver's seat 200 while the starting of the vehicle 1 is turned on, and if it is determined that the child C is seated, it may induce the child C to get off. In addition, the vehicle 1 may turn off the starting.

According to an aspect of the present disclosure, it is possible to provide a vehicle control apparatus and a vehicle control method capable of detecting that a child is seated a driver's seat. Thereby, it is possible to prevent accidents that may occur if a child drives the vehicle.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An apparatus for assisting driving of a host vehicle, the apparatus comprising:
a plurality of pressure sensors mounted in a driver's seat of the host vehicle; and
a controller electrically connected to the plurality of pressure sensors, and
wherein the controller is configured to:
receive an output signal of the plurality of pressure sensors,
determine whether a child is seated in the driver's seat based on the output signal, and
control a wireless communication module of the host vehicle to transmit an alarm to a user device registered in the host vehicle based on determining that the child is seated and the child inputs an input for starting the host vehicle.

2. The apparatus according to claim 1, wherein the plurality of pressure sensors comprises:
a first pressure sensor mounted in front of a seat body of the driver's seat;
a second pressure sensor mounted at a rear of a seat body of the driver's seat;
a third pressure sensor mounted on a lower side of a backrest of the driver's seat; and
a fourth pressure sensor mounted on an upper side of a backrest of the driver's seat.

3. The apparatus according to claim 2, wherein the controller is configured to determine that a child is seated in the driver's seat based on a pressure being not applied to at least one of the first pressure sensor, the second pressure sensor, the third pressure sensor, and the fourth pressure sensor.

4. The apparatus according to claim 2, wherein the controller is configured to:
estimate a weight of a driver seated in the driver's seat based on a pressure applied to the first pressure sensor, the second pressure sensor, the third pressure sensor, and the fourth pressure sensor, and
determine that a child is seated in the driver's seat based on the comparison between the estimated weight and a reference weight.

5. The apparatus according to claim 1, wherein the controller is configured to control a display or a speaker or a seat vibration module of the host vehicle to output an image message, sound message, or tactile message that induces a child to get off.

6. The apparatus according to claim 1, wherein the controller is configured to prevent starting of the host vehicle based on determining that a child is seated in the driver's seat while a starting of the host vehicle is turned off.

7. The apparatus according to claim 1, wherein the controller is configured to turn off a starting of the host vehicle based on determining that a child is seated in the driver's seat while a starting of the host vehicle is turned on.

8. A vehicle including the apparatus of claim 1.

9. An apparatus for assisting driving of a host vehicle, the apparatus comprising:
a camera module configured to photograph a driver's seat of the host vehicle; and
a controller electrically connected to the camera module, and
wherein the controller is configured to:
receive an image data of the camera module,
determine whether a child is seated in the driver's seat based on the image data, and
control a wireless communication module of the host vehicle to transmit an alarm to a user device registered in the host vehicle based on determining that the child is seated and the child inputs an input for starting the host vehicle.

10. The apparatus according to claim 9, wherein the camera is mounted on an interior ceiling or a rear view mirror of the host vehicle, and configured to acquire an image data comprising a driver seated in the driver's seat.

11. The apparatus according to claim 9, wherein the controller is configured to:
recognize a face of a driver seated in the driver's seat based on the image data, and
determine that a child is seated in the driver's seat based on the recognized coordinate of the face being below the reference position.

12. A vehicle including the apparatus of claim 9.

13. An apparatus for assisting driving of a host vehicle, the apparatus comprising:
a touch screen configured to acquire a touch input of a driver of the host vehicle; and
a controller electrically connected to the touch screen, and
wherein the controller is configured to:
receive a touch input of the touch screen,
determine whether a child is seated in the driver's seat based on the touch input, and
control a wireless communication module of the host vehicle to transmit an alarm to a user device registered in the host vehicle based on determining that the child is seated and the child inputs an input for starting the host vehicle.

14. The apparatus according to claim 13, wherein the controller is configured to:
determine a distance between an uppermost end and a lowermost end of the touch input based on the touch input, and
determine that a child is seated in the driver's seat based on that the distance is less than the reference distance.

15. A vehicle including the apparatus of claim 13.
